(19) United States
(12) Patent Application Publication
(10) Pub. No.: US 2024/0117575 A1
(43) Pub. Date: Apr. 11, 2024

(54) INFRASTRUCTURE DIAGNOSTIC DEVICE, INFRASTRUCTURE DIAGNOSTIC METHOD, AND RECORDING MEDIUM

(71) Applicant: NEC Corporation, Minato-ku, Tokyo (JP)

(72) Inventors: Nana Jumonji, Tokyo (JP); Yosuke Kimura, Tokyo (JP); Chisato Sugawara, Tokyo (JP); Toru Takami, Tokyo (JP); Hiroshi Nakasato, Tokyo (JP)

(73) Assignee: NEC Corporation, Minato-ku, Tokyo (JP)

(21) Appl. No.: 18/275,962

(22) PCT Filed: Feb. 22, 2021
(86) PCT No.: PCT/JP2021/006640

§ 371 Date: Aug. 4, 2023

(51) Int. Cl. E01C 23/01; G01C 21/34

(52) U.S. Cl. CPC E01C 23/01; G01C 21/3446

(57) ABSTRACT

An infrastructure diagnostic device according to an aspect of the present disclosure includes: at least one memory configured to store instructions; and at least one processor configured to execute the instructions to: generate a road section by dividing, by meshes, a movement path of a moving body collected from the moving body moving on a road, the meshes being obtained by dividing a ground surface into a predetermined size; and determine and output a state of the road section based on sensor information of the road section collected from the moving body.

### TECHNICAL FIELD

The present disclosure relates to an infrastructure diagnostic device, an infrastructure diagnostic method, and a recording medium.

### BACKGROUND ART

In general, in the management of infrastructures related to roads such as a road surface, a sign, and a guardrail (hereinafter, also referred to as road-related infrastructures), a section obtained by dividing a route (road) into a certain size is defined, and the state of the road-related infrastructure is managed by associating the section with position information. How to divide and manage the route varies depending on a business operator (local government or the like). There is a case where how to divide is not provided by a business operator (local government or the like).

For example, PTL 1 and PTL 2 disclose a method of dividing a road in map information into a predetermined size such as a mesh as a dividing method of managing a road.

### CITATION LIST

### Patent Literature

PTL 1: JP 2019-100136 A
PTL 2: WO 2014/171070 A1

### SUMMARY OF INVENTION

### Technical Problem

The position of the road changes due to various factors such as maintenance and construction by a business operator (local government or the like). However, in general, the latest map information reflecting the actual position of the road is not always obtained. In a case where the map information is not the latest, the method of PTL 1 or PTL 2 cannot manage the state of the road-related infrastructure by a section based on an actual road.

One object of the present disclosure is to solve the above-described problem and to provide an infrastructure diagnostic device, an infrastructure diagnostic method, and a recording medium capable of managing a state of a road-related infrastructure by a section based on an actual road.

### Solution to Problem

An infrastructure diagnostic device according to one aspect of the present disclosure includes a section generation means that generates a road section by dividing, by meshes, a movement path of a moving body collected from the moving body moving on a road, the meshes being obtained by dividing a ground surface into a predetermined size, and a state determination means that determines and outputs a state of the road section based on sensor information of the road section collected from the moving body.

An infrastructure management method according to one aspect of the present disclosure includes generating a road section by dividing, by meshes, a movement path of a moving body collected from the moving body moving on a road, the meshes being obtained by dividing a ground surface into a predetermined size, and determining and outputting a state of the road section based on sensor information of the road section collected from the moving body.

A recording medium according to one aspect of the present disclosure records a program for causing a computer to execute processing of generating a road section by dividing, by meshes, a movement path of a moving body collected from the moving body moving on a road, the meshes being obtained by dividing a ground surface into a predetermined size, and determining and outputting a state of the road section based on sensor information of the road section collected from the moving body.

### Advantageous Effects of Invention

An effect of the present disclosure is that the state of a road-related infrastructure can be managed by a section based on an actual road.

### BRIEF DESCRIPTION OF DRAWINGS

FIG. 1 is a block diagram illustrating a configuration of an infrastructure management system 10 according to a first example embodiment.

FIG. 2 is a block diagram illustrating an example of a configuration of an infrastructure diagnostic device according to the first example embodiment.

FIG. 3 is a diagram illustrating an example of sensor information according to the first example embodiment.

FIG. 4 is a diagram illustrating an example in which mesh IDs are associated with sensor information according to the first example embodiment.

FIG. 5 is a diagram illustrating an example of section information according to the first example embodiment.

FIG. 6 is a flowchart illustrating road section state determination processing of the infrastructure diagnostic device according to the first example embodiment.

FIG. 7 is a diagram describing generation of a road section in a case where there is one movement path in a mesh according to the first example embodiment.

FIG. 8 is a diagram describing generation of a road section in a case where there is a plurality of movement paths in a mesh according to the first example embodiment.

FIG. 9 is a diagram illustrating an example of a determination result according to the first example embodiment.

FIG. 10 is a diagram illustrating a display example of a determination result according to the first example embodiment.

FIG. 11 is a diagram describing generation (approximation with a curve) of a road section according to the first example embodiment.

FIG. 12 is a block diagram illustrating a configuration of an infrastructure diagnostic device according to a second example embodiment.

FIG. 13 is a diagram illustrating an example of route information according to the second example embodiment.

FIG. 14 is a flowchart illustrating route determination processing of an infrastructure diagnostic device 200 according to the second example embodiment.

FIG. 15 is a diagram describing detection of a candidate of a road section that can be coupled in an adjacent mesh according to the second example embodiment.

FIG. 16 is a diagram illustrating a display example of a determination result for each route according to the second example embodiment.

FIG. 17 is a diagram illustrating an example of route information according to a modification of the second example embodiment.

FIG. 18 is a diagram describing extraction of a route candidate according to a modification of the second example embodiment.

FIG. 19 is a block diagram illustrating a configuration of an infrastructure diagnostic device 1 according to a third example embodiment.

FIG. 20 is a block diagram illustrating an example of a hardware configuration of a computer 500.

### EXAMPLE EMBODIMENT

Example embodiments will be described in detail with reference to the drawings. In the drawings and the example embodiments described in the specification, the same reference signs are given to the same components, and the description thereof will be omitted as appropriate.

In the following example embodiments, the road-related infrastructure is, for example, a road surface, a sign, a guardrail, a road surface sign, a curve mirror, or the like. The business operator is, for example, a public institution, a local government, a management company, or the like that manages these infrastructures.

### First Example Embodiment

The first example embodiment will be described. Here, a case where the road-related infrastructure is a road surface will be described as an example.

(System Configuration)

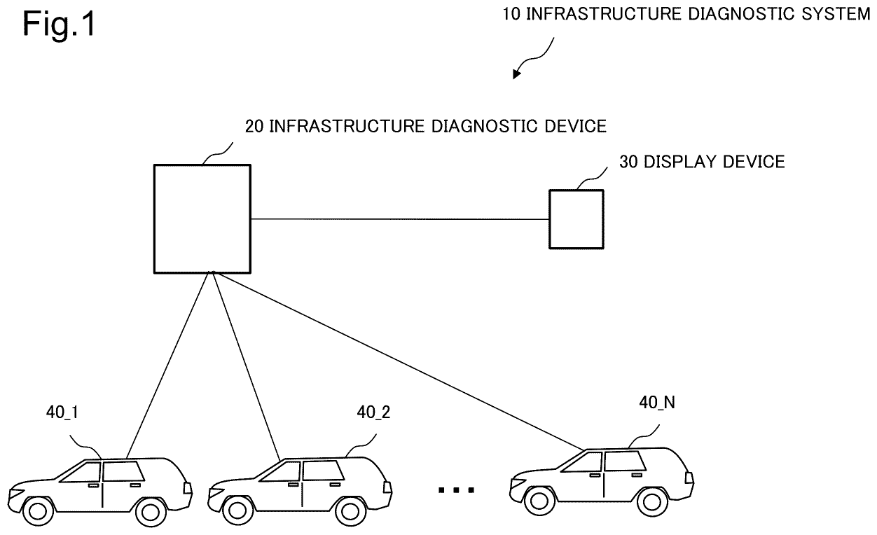

First, a configuration of an infrastructure diagnostic system 10 according to the first example embodiment will be described. FIG. 1 is a block diagram illustrating a configuration of the infrastructure diagnostic system 10 according to the first example embodiment. Referring to FIG. 1, the infrastructure diagnostic system 10 includes an infrastructure diagnostic device 20, a display device 30, and a plurality of vehicles 40_1, 40_2, . . . 40_N (N is a natural number) (hereinafter, collectively referred to as a vehicle 40) that is a moving body. The moving body may be a motorcycle, a bicycle, a drone, a robot or a vehicle with a self-driving function, or a person (pedestrian).

The vehicle 40 acquires predetermined sensor information acquired by a mounted sensor. The sensor information includes an image, acceleration, acquisition date and time, a position, and the like. The image is, for example, an image of a road-related infrastructure captured (acquired) by an imaging device such as a camera of a drive recorder mounted on the vehicle 40 while traveling on a road. The acceleration is obtained by expressing unevenness of the road surface of a road detected (acquired) by, for example, an acceleration sensor as vibration in an up-down direction while traveling on the road. The position is a position acquired by a position detection sensor such as a global positioning system (GPS) when an image is captured by the imaging device or when acceleration is acquired by the acceleration sensor. The vehicle 40 transmits the sensor information including the image, the acceleration, the acquisition date and time of these pieces of information, and the position to the infrastructure diagnostic device 20. For example, latitude and longitude may be used as the position. In the present example embodiment, the position will be described using latitude and longitude. In the present example embodiment, a case where both the image and the acceleration are included in the sensor information will be described, but the present example embodiment is not limited thereto, and it is sufficient if at least one of the image and the acceleration is included.

The infrastructure diagnostic device 20 divides the road into sections for managing the road-related infrastructure based on the sensor information transmitted from the vehicle 40, determines the state of the road-related infrastructure for each of the sections, and displays the determination result on the display device 30.

The infrastructure diagnostic device 20 and the display device 30 are disposed, for example, in an equipment management facility of a business operator. The infrastructure diagnostic device 20 and the display device 30 may be integrated or separated. The infrastructure diagnostic device 20 may be disposed in other than the equipment management facility of the business operator. In this case, the infrastructure diagnostic device 20 may be achieved by a cloud computing system.

A known technique using image analysis or acceleration is used as a method of determining the state of the road-related infrastructure based on the sensor information. Examples of the determination using image analysis include a method of analyzing the state of the road-related infrastructure using artificial intelligence (AI). Examples of the determination using the acceleration include a method of determining the degree of unevenness of the road surface using the acceleration in a direction perpendicular to the road surface. The infrastructure diagnostic device 20 outputs the determination result of each road section to the staff of the equipment management facility of the business operator via the display device 30.

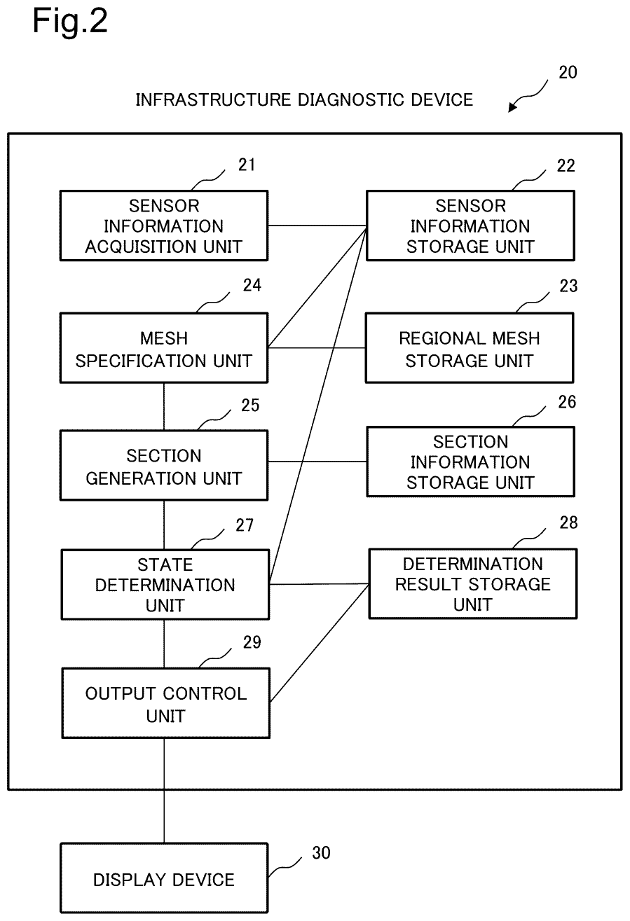

FIG. 2 is a block diagram illustrating an example of a configuration of the infrastructure diagnostic device 20 according to the first example embodiment. As illustrated in FIG. 2, the infrastructure diagnostic device 20 includes a sensor information acquisition unit 21, a sensor information storage unit 22, a regional mesh storage unit 23, a mesh specification unit 24, a section generation unit 25, a section information storage unit 26, a state determination unit 27, a determination result storage unit 28, and an output control unit 29.

The sensor information acquisition unit 21 acquires the sensor information from the vehicle 40. The sensor information acquisition unit 21 outputs the acquired sensor information to the sensor information storage unit 22.

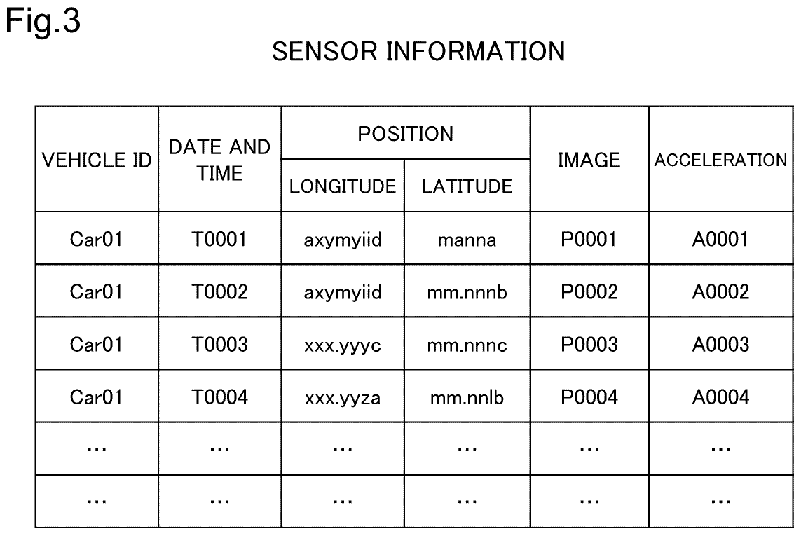

The sensor information storage unit 22 stores the sensor information output by the sensor information acquisition unit 21. FIG. 3 is a diagram illustrating an example of sensor information according to the first example embodiment. The example of the sensor information illustrated in FIG. 3 includes information regarding a vehicle identifier (ID) for identifying a vehicle that is a transmission source of the sensor information, a date and time, latitude and longitude that are a position, an image, and acceleration. The date and time indicates the date and time when the vehicle acquired the image and the acceleration. The latitude and longitude indicate the position where the image and the acceleration were acquired.

The regional mesh storage unit 23 stores meshes obtained by dividing the ground surface of each region into a predetermined size based on latitude lines and longitude lines, and mesh IDs (mesh codes) for identifying each of the meshes. Here, for example, as the mesh and the mesh ID, a standard regional mesh created by an administrative agency such as a country, a divided regional mesh obtained by further subdividing the standard regional mesh, or a regional mesh obtained by further subdividing the divided regional mesh may be used.

For example, a mesh having a side length of about 250 m or a mesh obtained by dividing it into two equal parts vertically and horizontally to have a side length of about 125 m may be used as the divided regional mesh. As the regional mesh, for example, a mesh having a side length of about 62.5 m or a mesh shorter than that may be used.

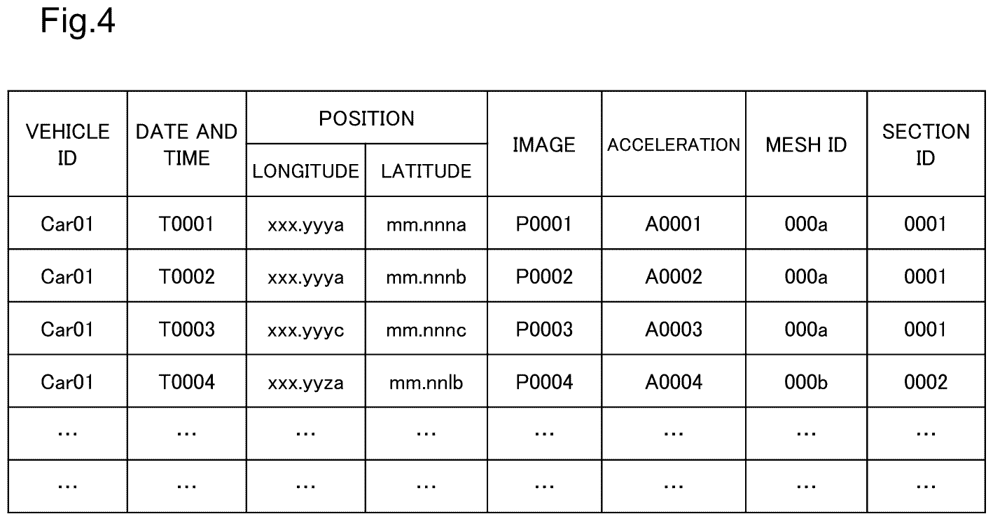

The mesh specification unit 24 acquires a position included in the sensor information from the sensor information storage unit 22, specifies the mesh ID based on the position and the mesh stored in the regional mesh storage unit 23, and associates the mesh ID with the sensor information. FIG. 4 is a diagram illustrating an example in which mesh IDs and section IDs are associated with sensor information according to the first example embodiment. For example, as illustrated in FIG. 4, the mesh specification unit 24 assigns a mesh ID of the mesh to each sensor information in the same mesh.

The section generation unit 25 generates a road section by dividing, by meshes, the movement path on which the vehicle 40 has moved based on the position included in the sensor information. The section generation unit 25 assigns a section ID to the generated road section in order to identify the road section in the mesh. Each road section is uniquely identified by a pair of the mesh ID and the section ID. For example, as illustrated in FIG. 4, the section generation unit 25 divides a series of pieces of sensor information related to the movement path of the vehicle having the same vehicle ID for each mesh ID, and assigns a section ID. In the present example embodiment, each road section is uniquely identified by a pair of the mesh ID and the section ID, but the present example embodiment is not limited thereto, and the section generation unit 25 may assign a predetermined identifier (for example, a road section ID or the like) to each road section and associate a pair of the mesh ID and the section ID with the predetermined identifier.

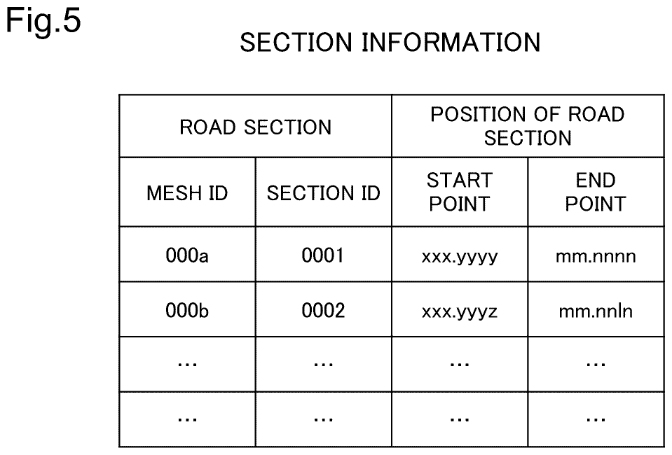

The section generation unit 25 outputs, to the section information storage unit 26, the start point and the end point of the road section and the section ID in association with each other as section information. FIG. 5 is a diagram illustrating an example of section information according to the first example embodiment. As illustrated in FIG. 5, in the section information, the start point and the end point of the road section are associated with the pair of the mesh ID and the section ID. FIGS. 4 and 5 are examples of a case where there is one road section in one mesh. The association between the section ID and the start point and the end point of the road section will be described below. The start point and the end point of the road section indicate the position of the road section in the mesh, and are also described as the position of the road section.

The section information storage unit 26 stores the section information generated by the section generation unit 25.

The state determination unit 27 determines the state of the road-related infrastructure of the road section based on the image and the acceleration included in the sensor information. Examples of a method of determining the state of the road-related infrastructure of the road section include a method using image recognition using artificial intelligence (AI) based on the acquired image, and a known method of detecting unevenness of a road surface using acceleration.

The state determination unit 27 outputs the state of the road-related infrastructure determined for each road section to the determination result storage unit 28.

The determination result storage unit 28 stores the state of the road-related infrastructure determined for each road section.

The output control unit 29 outputs the determined state of the road-related infrastructure for each road section in a predetermined display mode. For example, the output control unit 29 causes the display device 30 to display the determined state of the road-related infrastructure in a predetermined display mode.

Next, the operation of the first example embodiment will be described.

(Road Section State Determination Processing)

The road section state determination processing will be described. The road section state determination processing is processing of dividing the movement path of each vehicle 40 by meshes to generate a road section based on the sensor information transmitted from each vehicle 40, determining the state of the road-related infrastructure of the road section, and outputting a determination result.

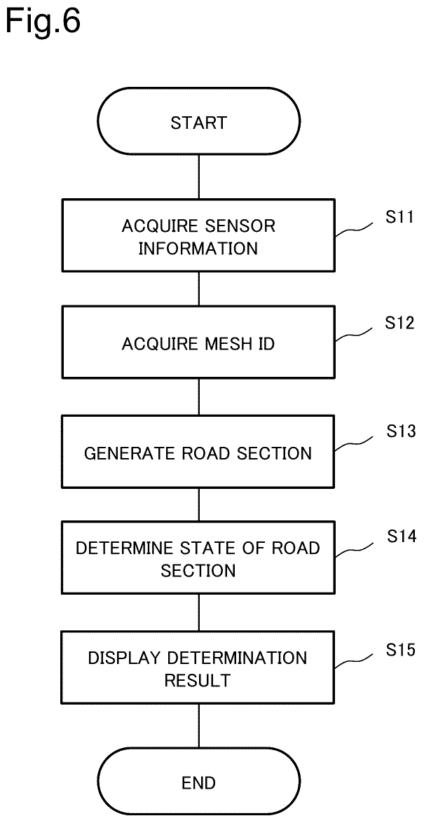

FIG. 6 is a flowchart illustrating road section state determination processing of the infrastructure diagnostic device 20 according to the first example embodiment.

In the infrastructure diagnostic system 10, the sensor information acquisition unit 21 of the infrastructure diagnostic device 20 acquires, for example, the sensor information (date and time, position (latitude and longitude), image, and acceleration) transmitted from the vehicle 40 (step S11). For example, the sensor information acquisition unit 21 acquires the sensor information as illustrated in FIG. 3. The sensor information acquisition unit 21 causes the sensor information storage unit 22 to store the acquired sensor information.

The mesh specification unit 24 acquires the sensor information from the sensor information storage unit 22. The mesh specification unit 24 refers to the regional mesh stored in the regional mesh storage unit 23 based on the position included in each piece of the acquired sensor information, specifies the mesh related to the position, and acquires the mesh ID of the mesh (step S12). For example, the mesh specification unit 24 specifies a mesh including a location indicated by the latitude and longitude of the sensor information, and acquires the mesh ID (mesh code) of the specified mesh. Then, the mesh specification unit 24 associates the sensor information with the mesh ID. For example, the mesh specification unit 24 assigns a mesh ID to the sensor information as illustrated in FIG. 4.

The section generation unit 25 generates a road section by dividing the movement path based on the position of the vehicle 40 included in the sensor information by the mesh specified by the mesh specification unit 24 (step S13). For example, the section generation unit 25 assigns a section ID to the sensor information as illustrated in FIG. 4, and generates section information as illustrated in FIG. 5.

Here, generation of a road section by the section generation unit will be described.

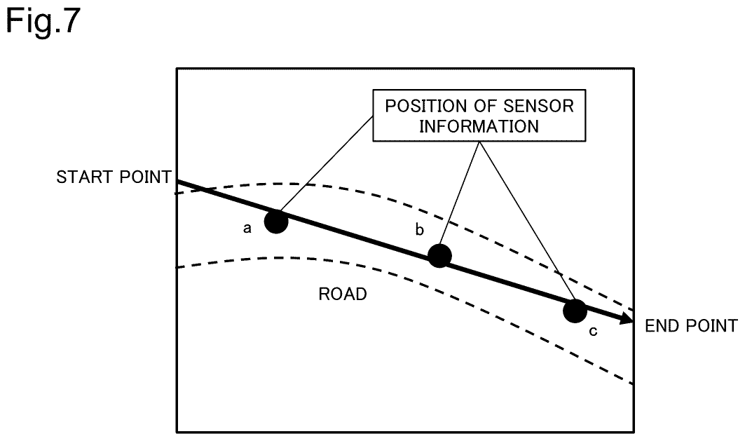

FIG. 7 is a diagram describing generation of a road section in a case where there is one movement path in a mesh according to the first example embodiment. In the example of the mesh illustrated in FIG. 7, points a to c, which are positions obtained from a series of pieces of sensor information related to the movement path of the vehicle having the same vehicle ID, are indicated on the road indicated by the dotted lines. Here, the traveling direction of the vehicle 40 is a direction from the point a to the point c (from left to right) in FIG. 7.

For example, as illustrated in FIG. 7, the section generation unit extrapolates the straight line up to the boundaries of the mesh by performing straight line approximation between the three points: the points a to c. Then, intersections between the extrapolated straight line and the boundaries of the mesh are set as the start point and the end point. The start point and the end point are determined by the traveling direction of the vehicle 40. In the example of FIG. 7, since movement (traveling) is performed from the point a to the point c (from left to right), the intersection on the point a side (left) is the start point, and the intersection on the point c side (right) is the end point. The section generation unit 25 sets a straight line connecting the start point and the end point as a road section. Then, the section generation unit 25 assigns a section ID to the road section. Here, the straight line may be defined by the position (latitude and longitude) of the start point and the position (latitude and longitude) of the end point.

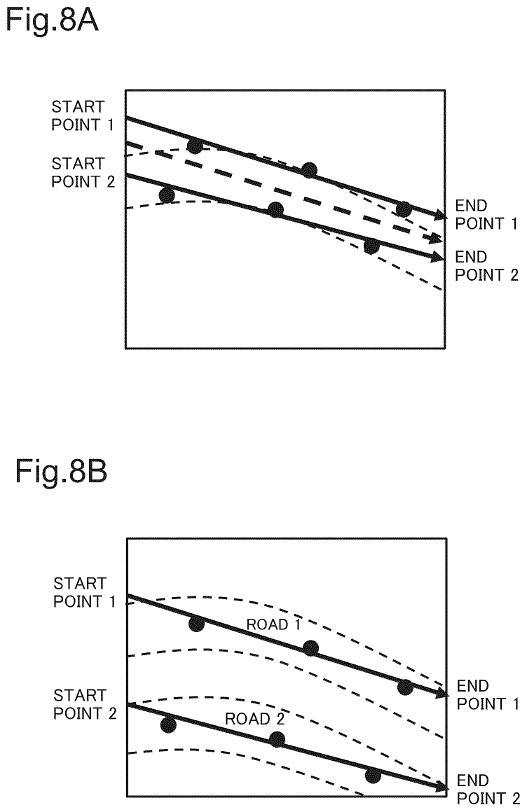

FIG. 8 is a diagram describing generation of a road section in a case where there is a plurality of movement paths in a mesh according to the first example embodiment. FIG. 8(a) illustrates a case where two approximate straight lines can be defined by, for example, traveling in different lanes, an error of a position detection sensor when a plurality of vehicles 40 moves on the same road in a certain mesh. However, even in such a case, when the traveling directions of the vehicles 40 are opposite to each other (for example, in the case of inbound and outbound), it may be determined that road sections are different. FIG. 8(b) illustrates a case where, for example, two approximate straight lines can be defined in a case where a plurality of vehicles 40 moves on different roads.

For example, the section generation unit 25 determines the situation illustrated in FIG. 8(a) (two movement paths on the same road) and the situation illustrated in FIG. 8(b) (movement path on each of different roads) based on the distance between the two straight lines. When the distance between the two straight lines is within a predetermined range, the section generation unit 25 determines that there are two movement paths on the same road as illustrated in FIG. 8(a), and generates one approximate straight line based on these two movement paths. In this case, for example, as illustrated in FIG. 8(a), the section generation unit 25 may define an approximate straight line for each set of sensor information acquired by each vehicle, and set an intermediate approximate straight line (a straight line indicated by the dotted line) as the road section. Then, the section generation unit 25 assigns a section ID to the road section.

When the distance between the two straight lines exceeds the predetermined range, the section generation unit 25 may determine that there is a movement path on each of different roads as illustrated in FIG. 8(b) and set each of them as the road section. Then, the section generation unit 25 assigns different section IDs to the respective road sections.

For example, when the distance between the two start points and the distance between the two end points are both within the predetermined range, the section generation unit 25 determines that the distance between the two straight lines is within the predetermined range. For example, when either one of the distance between the two start points and the distance between the two end points exceeds the predetermined range, the section generation unit 25 determines that the distance between the two straight lines exceeds the predetermined range.

The state determination unit 27 determines the state of the road surface of the road section based on the image and the acceleration included in the sensor information of each road section in the same mesh (step S14). Here, the determination of the state of the road surface of the road section will be described using the sensor information of FIG. 4 and the road section of FIG. 7.

In the road section (arrow) illustrated in FIG. 7, the sensor information is acquired at each of the points a to c. Here, it is assumed that pieces of sensor information (image and acceleration) of road sections (mesh IDs “0001”, section IDs “0001”), that is, date and time T0001 to T0003 in FIG. 4 are the pieces of sensor information of the points a to c. The acceleration of the sensor information is not actually the acceleration at each point, but is, for example, a value acquired within a predetermined distance before and after each point as the acceleration at each point.

The state determination unit 27 determines the state (deterioration) of the road surface at each point based on at least one of the image and the acceleration of each of the points a to c (calculates an index indicating the state of the road surface). Here, as an index indicating the state of the road surface determined based on the image, for example, a crack rate, a rutting amount, or the like may be used. For example, as an index indicating the state of the road surface determined based on the acceleration, flatness, an international roughness index (IRI), or the like may be used. Maintenance control index (MCI), which is an index calculated based on the crack rate, the rutting amount, and flatness, may be used.

The state determination unit 27 calculates the value of the index of the road section based on the value of the index calculated at each point included in the road section illustrated in FIG. 7. Then, the state determination unit 27 outputs the value of the index of the road section to the determination result storage unit 28 as a determination result. For example, the state determination unit 27 calculates the average value of the values of the indexes of the points a to c included in the road section as the value of the index of the road section “mesh ID “000a”, section ID “0001””. The state determination unit 27 is not limited thereto, and for example, may calculate a maximum value of the values of the indexes of the points a to c or a value calculated by another statistical processing with respect to the values of the indexes of the points a to c as the value of the index of the road section.

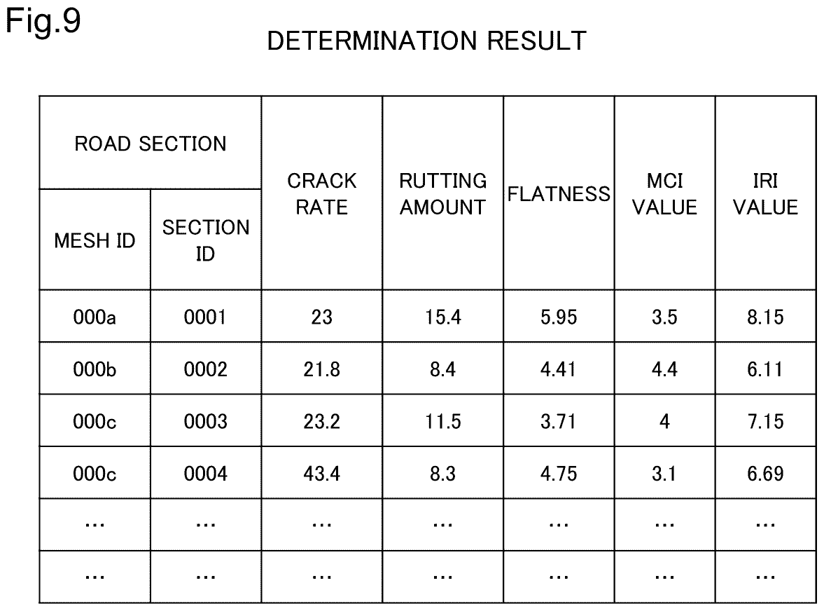

FIG. 9 is a diagram illustrating an example of a determination result according to the first example embodiment. Regarding the determination result of FIG. 9, for example, the state of the road surface of the road section {mesh ID “000a”, section ID “0001”} is calculated based on the image and the acceleration to which the road section {mesh ID “000a”, section ID “0001”} is assigned in the sensor information illustrated in FIG. 4. As illustrated in FIG. 9, when there are two road sections in the same mesh, for example, two section IDs “0003” and “0004” are assigned as indicated by mesh IDs “000c”.

The output control unit 29 acquires the determination result of the road section from the determination result storage unit 28, and causes, for example, the display device 30 to display the determination result (step S15). For example, the determination result may be displayed for each generated road section in a display mode according to the state of the road surface for each road section. In this case, for example, the output control unit 29 indicates the state of the road surface of the road section by the shading of an arrow indicating the road section. The output control unit 29 is not limited thereto, but may indicate the state of the road surface of the road section by, for example, the thickness, type, or the like of an arrow indicating the road section.

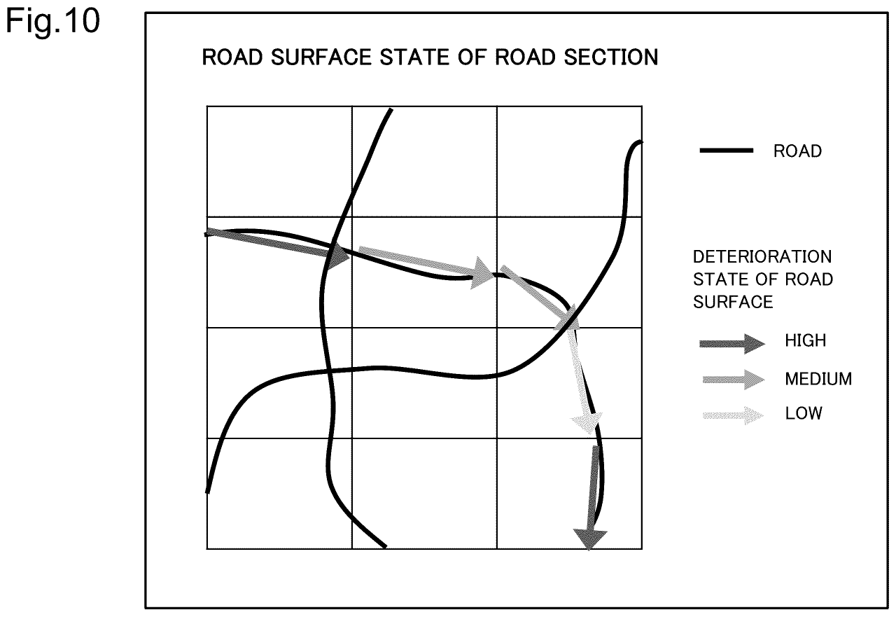

FIG. 10 is a diagram illustrating a display example of a determination result according to the first example embodiment. In the example of FIG. 10, the roads are roads obtained from map information and are indicated by the solid lines. The state of the road surface of each road section is indicated by shading of an arrow. For example, in FIG. 10, the road surface state is indicated by three levels of shading. The three levels of shading (darkest, next darkest, and lightest) correspond to high, medium, and low degrees of deterioration, respectively. The darkest arrow indicates, for example, that the degree of deterioration is high and it is necessary to take measures such as repair early. The next darkest arrow indicates, for example, that the degree of deterioration is medium, and the state may be observed for a while. The lightest arrow indicates a state in which the degree of deterioration is low.

Thus, the operation of the first example embodiment is completed.

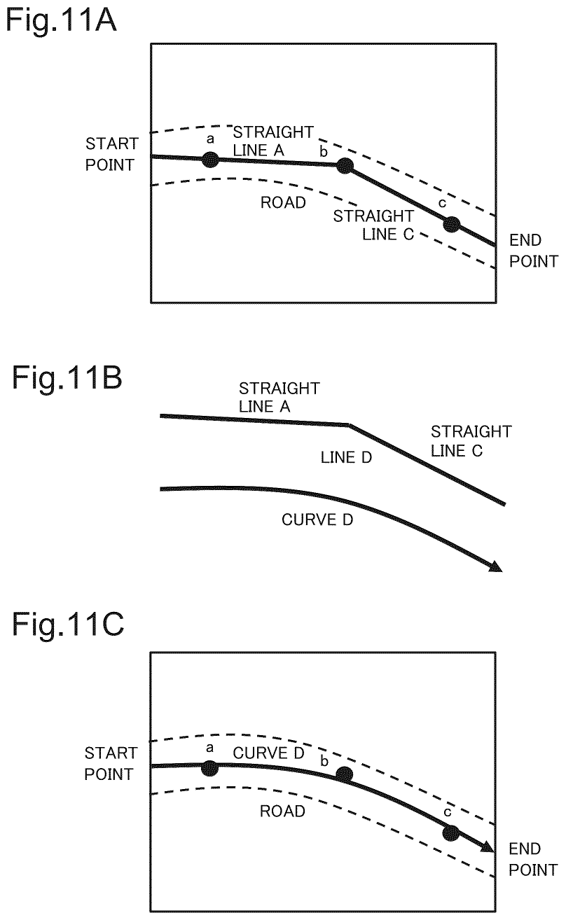

In the above description, the road section in each mesh is indicated by the straight line arrow, but it is not limited thereto, and for example, it may be indicated by a curved arrow that smoothly connects the positions where the sensor information is acquired in the mesh. FIG. 11 is a diagram describing generation (approximation with a curve) of a road section according to the first example embodiment. As illustrated in FIG. 11(a), points a to c are positions where the sensor information is acquired in the mesh. In the generation of the road section described above, as illustrated in FIG. 7, the section generation unit 25 extrapolates the straight line up to the boundaries of the mesh by performing straight line approximation between the three points: the points a to c. On the other hand, in the example of FIG. 11(a), the section generation unit 25 forms a straight line (hereinafter, also referred to as straight line A) that passes through the point a from the point b and is extrapolated to the boundary of the mesh. Similarly, the section generation unit 25 forms a straight line (hereinafter, also referred to as straight line C) that passes through the point a from the point b and is extrapolated to the boundary of the mesh. Next, as illustrated in FIG. 11(b), the section generation unit forms a curve D approximate to a line D coupling the straight line A and the straight line C. At this time, since the traveling direction of the vehicle 40 is the direction of the points a to c, the arrow is added to the end on the point c side. As a method of curve approximation, a known method such as curve fitting can be used. As illustrated in FIG. 11(c), the section generation unit 25 replaces the straight line A and the straight line B in FIG. 11(a) with the curve D such that the curve D approximates the points a to c.

### Effects of First Example Embodiment

According to the first example embodiment, the state of the road-related infrastructure can be managed by a section based on an actual road. This is because the section generation unit 25 of the infrastructure diagnostic device 20 generates a road section by dividing, by meshes obtained by dividing the ground surface into a predetermined size, the movement path of the moving body collected from the moving body moving on the road, and the state determination unit 27 determines and outputs the state of the road section based on the sensor information of the road section collected from the moving body.

### Second Example Embodiment

The second example embodiment will be described. In the second example embodiment, the infrastructure diagnostic device 200 couples road sections of adjacent meshes, determines a route, and manages the state of a road-related infrastructure for each route.

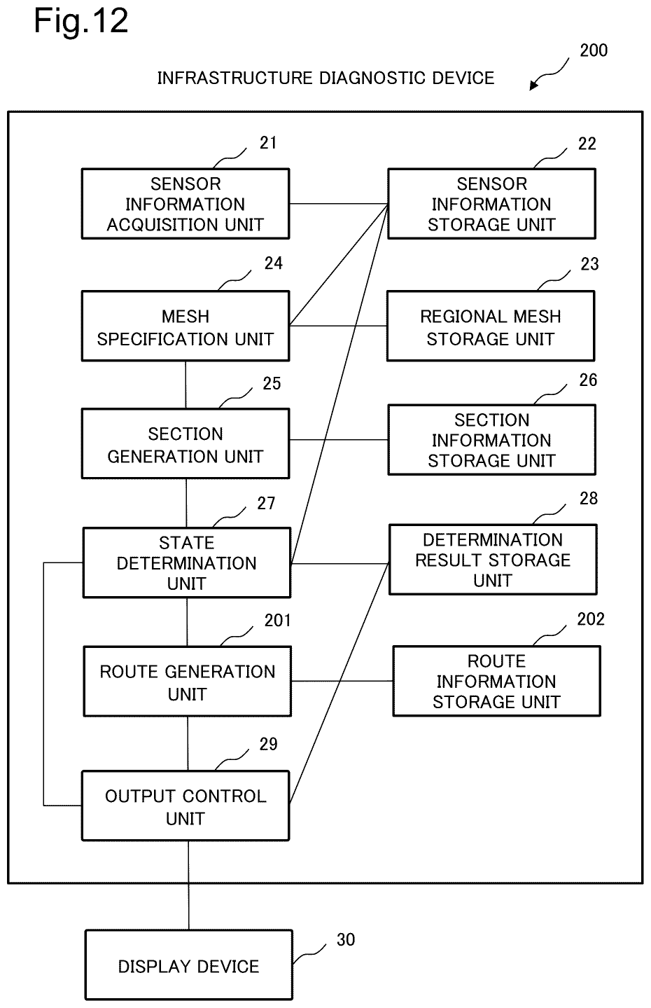

(Device Configuration) FIG. 12 is a block diagram illustrating a configuration of the infrastructure diagnostic device 200 according to the second example embodiment. As illustrated in FIG. 12, the infrastructure diagnostic device 200 according to the second example embodiment further includes a route generation unit 201 and a route information storage unit 202 in addition to the configuration (FIG. 2) of the infrastructure diagnostic device 20 according to the first example embodiment. In the second example embodiment, only portions different from those of the first example embodiment will be described with reference to FIG. 12.

The route generation unit 201 generates a route that is a set of road sections connected between adjacent meshes. For example, the route generation unit 201 receives designation of road sections to be connected between adjacent meshes, and generates a set of road sections including the designated road sections as the route.

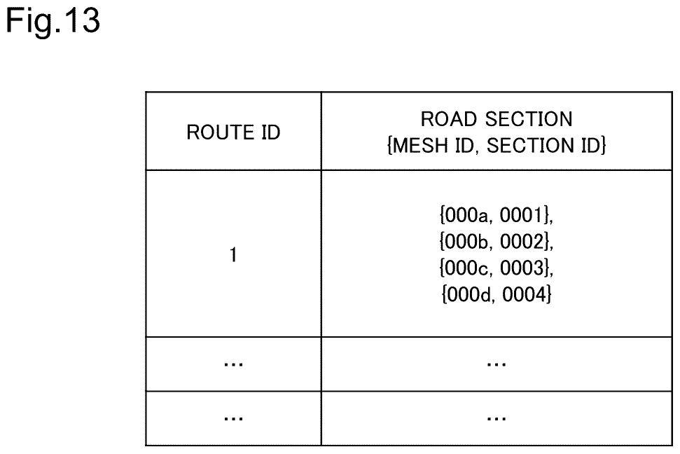

The route information storage unit 202 stores route information. The route information includes a route ID and a road section ID. FIG. 13 is a diagram illustrating an example of route information according to the second example embodiment. As illustrated in FIG. 13, the route information includes, for example, a set of the route IDs and “pairs of the mesh IDs and the section IDs” for identifying road sections.

Next, the operation of the second example embodiment will be described. In the second example embodiment, route determination processing is added to the road section state determination processing according to the first example embodiment. The route determination processing is executed, for example, after a plurality of road sections is generated by the road section state determination processing according to the first example embodiment.

(Route Determination Processing)

The route determination processing will be described. The route determination processing is processing of determining a route by coupling road sections that can be connected between adjacent meshes.

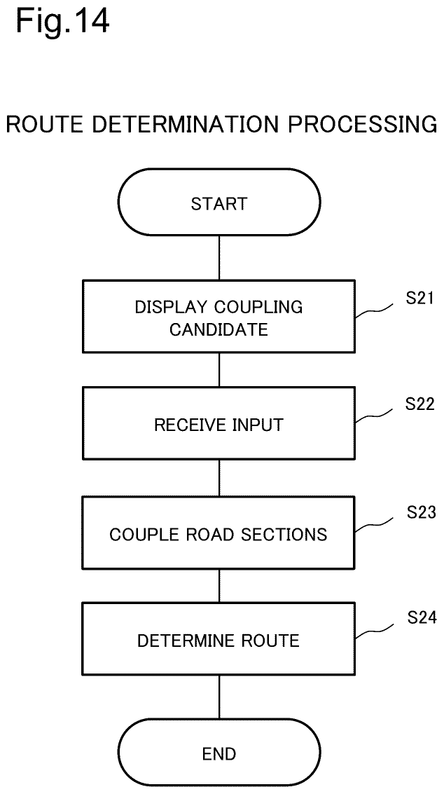

FIG. 14 is a flowchart illustrating route determination processing of the infrastructure diagnostic device 200 according to the second example embodiment. Here, it is assumed that a plurality of road sections is generated by the road section state determination processing described in the first example embodiment.

For a road section in a certain mesh, when there is a candidate of a road section that can be coupled in a mesh adjacent to the mesh (hereinafter, also referred to as a coupling candidate), the route generation unit 201 of the infrastructure diagnostic device 200 outputs the coupling candidate to the output control unit 29. The output control unit 29 causes the display device 30 to display the coupling candidate (step S21).

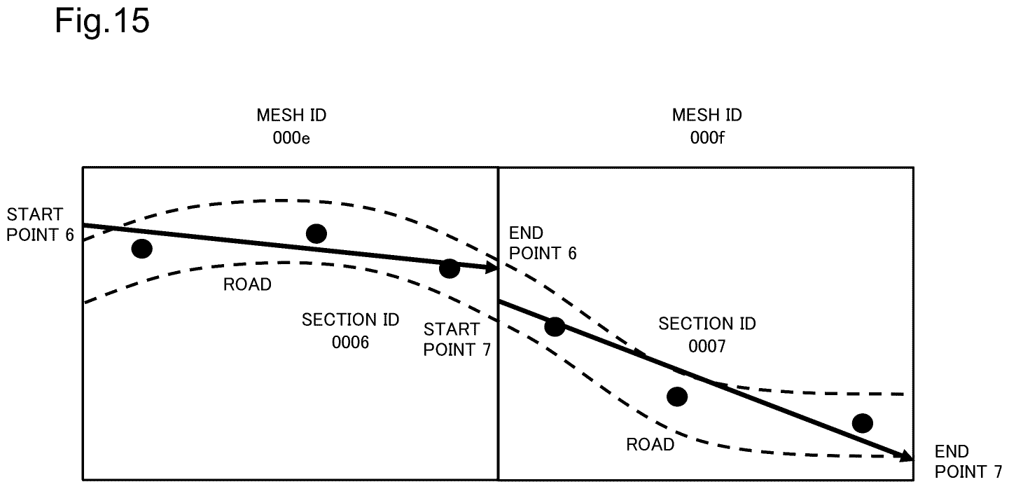

Here, detection of a candidate of a road section that can be coupled in an adjacent mesh will be described with reference to FIG. 15. FIG. 15 is a diagram describing detection of a candidate of a road section that can be coupled in an adjacent mesh according to the second example embodiment. FIG. 15 is a diagram in which some of a plurality of meshes is cut out, and actually, meshes exist around the cut out meshes.

It is assumed that the route generation unit 201 focuses on a mesh with the mesh ID “000e”. At this time, the route generation unit 201 specifies one side of the mesh on which end point 6 of the road section (section ID “0006”) in the mesh (000e) of interest is located. The route generation unit 201 focuses on a mesh (000f) adjacent to the specified one side. The route generation unit 201 detects the start points of all road sections in a mesh (000f). In the example of FIG. 15, the road section in the mesh (000f) is the road section (section ID “0007”), and the start point of the road section is a start point 7. The route generation unit 201 calculates a difference in position between the end point 6 of the road section (section ID “0006”) and the start point 7 of the road section (section ID “0007”) in the adjacent mesh. When the difference is within a predetermined range, the route generation unit 201 determines that the road sections can be coupled. In this case, the route generation unit 201 determines that the road section (section ID “0007”) can be coupled to the section (section ID “0006”). The route generation unit 201 outputs the road section (section ID “0007”) to the output control unit 29 as a coupling candidate. The output control unit 29 causes the display device to display the acquired coupling candidate to allow an administrator or the like to confirm the coupling candidate. In a case like the example of FIG. 15, for example, the output control unit 29 may present that the road section (section ID “0007”) is a coupling candidate to the administrator or the like in an easy-to-understand manner in a display mode of highlight display in which the road section (section ID “0007”) blinks.

The route generation unit 201 may use map information to determine whether road sections can be coupled. Specifically, the route generation unit 201 may relax the condition of the range of the difference between the start point and the end point when it is found that the road near the road section of interest is a single road based on the map information.

Regarding the determination as to whether other road sections can be coupled, the route generation unit 201 may use, for example, temporal transition of the position of the vehicle 40. Specifically, when one vehicle 40 is traveling temporally continuously in two road sections across meshes, the route generation unit 201 may determine that the road sections can be coupled to each other and output the road sections as coupling candidates to the output control unit 29.

Further, the route generation unit 201 may not determine whether the road sections can be coupled by using a binary value: possible or impossible, but may calculate the coupling possibility indicating the degree of couplability, for example, according to the magnitude of the difference between the start point and the end point. The coupling possibility may be divided, for example, into three levels: “high”, “medium”, and “low”. Then, the output control unit 29 may perform display in different display modes according to the coupling possibility. The display mode may be, for example, different colors or different shades according to the three levels of coupling possibility.

Next, the route generation unit 201 receives an input of confirmation regarding the coupling candidate from the administrator or the like (step S22). The reception of the input of confirmation may be performed, for example, by the administrator or the like clicking a road section blinking as a coupling candidate. When there is one coupling candidate as in the example of FIG. 15, the route generation unit 201 may be configured to couple the road section (section ID “0007”) to the section (section ID “0006”) and display the sections, and cause the administrator to select, for example, “Yes” or “No” to confirm whether to perform the coupling. In the example of FIG. 15, when the administrator selects rejection such as “No”, the route generation unit 201 does not detect any other coupling candidates and thus may receive an input of a next instruction from the administrator.

The route generation unit 201 couples a target road section and the road section, which is the coupling candidate, confirmed by the administrator or the like (step S23). For example, the road sections may be coupled by associating the target road section with the road section, which is the coupling candidate. That is, the coupling of the road sections may be achieved by arranging pairs of mesh IDs and route IDs indicating the road sections in the order of coupling.

The route generation unit 201 assigns a route ID to the road sections coupled in step S23 and determines a route (step S24). The route generation unit 201 associates the route ID with a set of “pairs of mesh IDs and route IDs” indicating the coupled road sections, and outputs the route ID and the set to the route information storage unit 202 as route information.

In the above description, the route is determined in step S24, but in the input reception processing in step S22, after the selection to determine the route is received from the administrator or the like, the route ID may be determined, and the road sections to be coupled may be sequentially associated with the route ID.

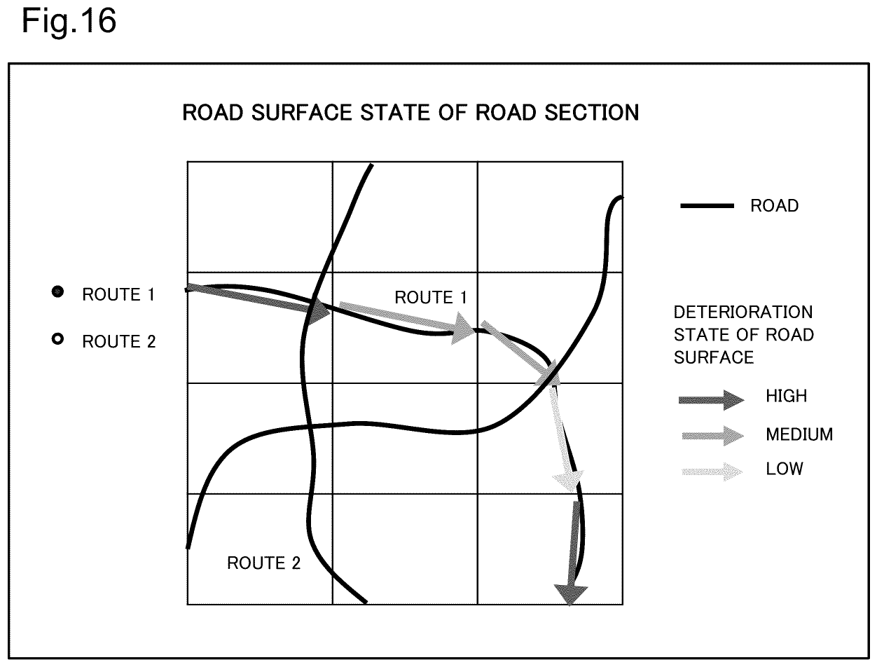

The output control unit 29 causes the display device 30 to display the coupled road sections as the route. FIG. 16 is a diagram illustrating a display example of a determination result for each route according to the second example embodiment. In the example of FIG. 16, since a route 1 and a route 2 are generated and the route 1 is selected, only the arrow indicating the road surface state of the route 1 is displayed.

Thus, the operation of the second example embodiment is completed.

### Effects of Second Example Embodiment

According to the second example embodiment, the state of the route of the road-related infrastructure can be managed for each section based on an actual road. This is because the route generation unit 201 receives designation of road sections to be connected between adjacent meshes, and generates a set of road sections including the designated road sections as the route.

### Modification of Second Example Embodiment

A modification of the second example embodiment will be described. In a modification of the second example embodiment, as route information, in a case where a plurality of positions (for example, latitude and longitude) on a route to be managed is designated, a set of road sections close to the positions is extracted, the set of road sections is presented to the administrator or the like as a route candidate, and confirmation of the route candidate is performed.

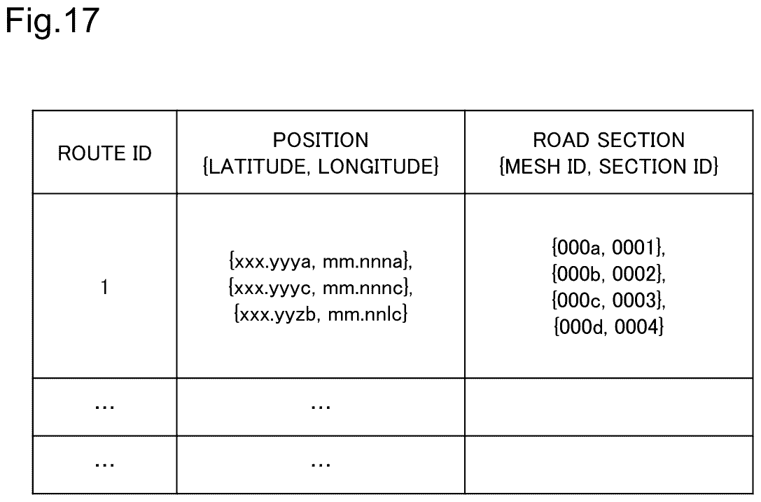

FIG. 17 is a diagram illustrating an example of route information according to a modification of the second example embodiment. Referring to FIG. 17, the route information includes a route ID indicating a route, a set of positions (latitude and longitude) on the route, and a set of “pairs of mesh IDs and section IDs” for identifying road sections. Here, it is assumed that a set of positions (latitude and longitude) on the route is designated in advance by the administrator or the like.

Next, extraction of a route candidate will be described.

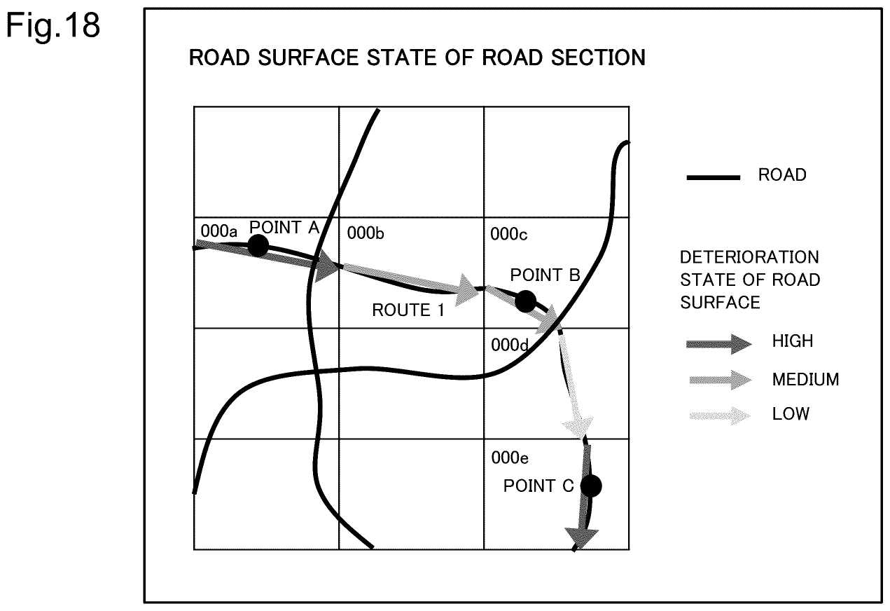

FIG. 18 is a diagram describing extraction of a route candidate according to a modification of the second example embodiment. In FIG. 18, points A to C are set on a road defined as a route 1. Here, it is assumed that the points A to C are positions on the route indicated in the route information of FIG. 17 (positions designated in advance by the administrator or the like).

For example, it is assumed that the vehicle 40 moves on the route 1, and a road section is generated by dividing the movement path by meshes having mesh IDs “000a” to “000e” as illustrated in FIG. 18. These road sections are assumed to be couplable.

For example, in each of the meshes of the points A to C, the route generation unit 201 compares the set of the positions (start points and end points) of the road sections and the positions of the sensor information used at the time of generating the road sections with the points on the route in the meshes. Specifically, when the comparison result is within a predetermined range, the route generation unit 201 determines that the road sections are candidates constituting the route. The route generation unit 201 determines that other road sections capable of coupling the road sections determined to be candidates constituting the route between non-adjacent meshes are also candidates constituting the same route.

In the example of FIG. 18, the route generation unit 201 determines road sections with mesh IDs “000a”, “000c”, and “000e” as candidates constituting the route 1. The route generation unit 201 also determines that these road sections and the road sections therebetween, that is, the road sections with mesh IDs “000b” and “000d” as candidates constituting the route 1.

The output control unit 29 presents the road sections determined as candidates constituting the route to the administrator or the like. The candidates may be presented to the administrator or the like by sequentially presenting the road sections, which are candidates, or by presenting a set of road sections to be coupled. Here, the confirmation of the presented candidates by the administrator or the like may be performed by a method similar to the processing of confirming the coupling candidates in step S22 according to the second example embodiment. When the presented candidates are confirmed as candidates constituting the route by the administrator or the like, the route generation unit 201 associates the route ID with a set of “pairs of mesh IDs and route IDs” indicating the coupled road sections, and sets the route ID and the set in the route information.

As described above, when a plurality of positions on the route to be managed is designated in advance, the state of the route of the road-related infrastructure can be more easily managed for each section based on an actual road.

### Third Example Embodiment

The third example embodiment will be described.

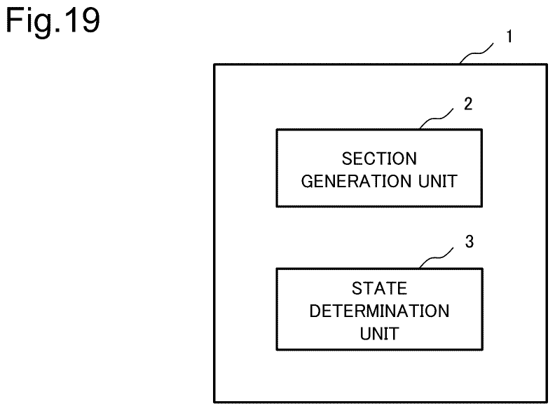

FIG. 19 is a block diagram illustrating a configuration of an infrastructure diagnostic device 1 according to the third example embodiment. Referring to FIG. 19, the infrastructure diagnostic device 1 includes a section generation unit 2 and a state determination unit 3. The section generation unit 2 and the state determination unit 3 are an example embodiment of a section generation means and a state determination means, respectively.

The section generation unit 2 generates a road section by dividing, by meshes obtained by dividing the ground surface into a predetermined size, the movement path of the moving body collected from the moving body moving on the road. The state determination unit 3 determines and outputs the state of the road section based on the sensor information of the road section collected from the moving body.

Next, effects of the third example embodiment will be described.

According to the third example embodiment, the state of the road-related infrastructure can be managed by a section based on an actual road. This is because the section generation unit 2 generates a road section by dividing, by meshes obtained by dividing the ground surface into a predetermined size, the movement path of the moving body collected from the moving body moving on the road, and the state determination unit 3 determines and outputs the state of the road section based on the sensor information of the road section collected from the moving body.

(Hardware Configuration)

In each of the example embodiments described above, each component of the infrastructure diagnostic devices 1, 20, and 200 indicates a block in units of functions. Some or all of components of the infrastructure diagnostic devices 1, 20, and 200 may be achieved by any combination of a computer 500 and a program. This program may be recorded in a non-volatile recording medium. The non-volatile recording medium is, for example, compact disc read only memory (CD-ROM), a digital versatile disc (DVD), a solid state drive (SSD), or the like.

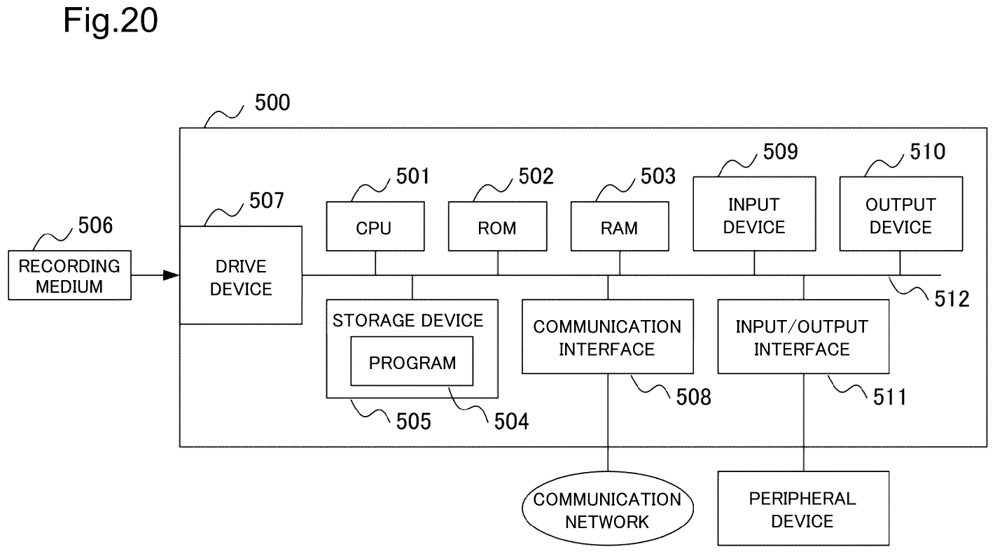

FIG. 20 is a block diagram illustrating an example of a hardware configuration of the computer 500. Referring to FIG. 20, the computer 500 includes, for example, a central processing unit (CPU) 501, read only memory (ROM) 502, random access memory (RAM) 503, a program 504, a storage device 505, a drive device 507, a communication interface 508, an input device 509, an output device 510, an input/output interface 511, and a bus 512.

The program 504 includes instructions for achieving the functions of the infrastructure diagnostic devices 1, 20, and 200. The program 504 is stored in advance in the ROM 502, the RAM 503, and the storage device 505. The CPU 501 achieves the functions of the infrastructure diagnostic devices 1, 20, and 200 by executing the instructions included in the program 504. For example, the CPU 501 of the infrastructure diagnostic device 20 and 200 executes instructions included in the program 504, thereby achieving the functions of the sensor information acquisition unit 21, the mesh specification unit 24, the section generation unit 25, the state determination unit 27, and the output control unit 29. The RAM 503 may store data processed by the functions of the infrastructure diagnostic device 20 and 200. For example, the RAM 503 of the infrastructure diagnostic device 20 and 200 may store data (sensor information) of the sensor information storage unit 22, data (mesh and mesh ID) of the regional mesh storage unit 23, data (section information) of the section information storage unit 26, data (determination result) of the determination result storage unit 28, and the like.

The drive device 507 reads and writes with respect to a recording medium 506. The communication interface 508 provides an interface with a communication network. The input device 509 is, for example, a mouse, a keyboard, or the like, and receives an input of information from an operator or the like. The output device 510 is, for example, a display, and outputs (displays) information to the operator or the like. The input/output interface 511 provides an interface with a peripheral device. The bus 512 connects the components of the hardware. The program 504 may be supplied to the CPU 501 via a communication network, or may be stored in the recording medium 506 in advance, read by the drive device 507, and supplied to the CPU 501.

The hardware configuration illustrated in FIG. 20 is an example, and other components may be added or some components may not be included.

There are various modifications for the method of achieving the infrastructure diagnostic devices 1, 20, and 200. For example, the infrastructure diagnostic devices 1, 20, and 200 may be achieved by any combination of a computer and a program different for each component. A plurality of components included in the infrastructure diagnostic devices 1, 20, and 200 may be achieved by any combination of one computer and a program.

Some or all of the components of the infrastructure diagnostic devices 1, 20, and 200 may be achieved by general-purpose or dedicated circuitry including a processor or the like, or a combination thereof. These circuitries may be configured by a single chip or may be configured by a plurality of chips connected via a bus. Some or all of the components of the infrastructure diagnostic devices 1, 20, and 200 may be achieved by a combination of the above-described circuitry or the like and the program.

In a case where some or all of the components of the infrastructure diagnostic devices 1, 20, and 200 are achieved by a plurality of computers, circuitries, and the like, the plurality of computers, circuitries, and the like may be disposed in a centralized manner or may be disposed in a distributed manner.

While the present disclosure has been described with reference to the example embodiments, the present disclosure is not limited to the example embodiments described above. Various changes that can be understood by those skilled in the art can be made to the configuration and details of the present disclosure within the scope of the present disclosure. The configurations in the example embodiments can be combined with each other without departing from the scope of the present disclosure.

### REFERENCE SIGNS LIST

1, 20, 200 infrastructure diagnostic device
2, 25 section generation unit
3, 27 state determination unit
10 infrastructure diagnostic system
21 sensor information acquisition unit
22 sensor information storage unit
23 regional mesh storage unit
24 mesh specification unit
26 section information storage unit
28 determination result storage unit
29 output control unit
30 display device
40 vehicle
201 route generation unit
202 route information storage unit
500 computer
501 CPU
502 ROM
503 RAM
504 program
505 storage device
506 recording medium
507 drive device
508 communication interface
509 input device
510 output device
511 input/output interface
512 bus

What is claimed is:

1. An infrastructure diagnostic device comprising:
at least one memory configured to store instructions; and
at least one processor configured to execute the instructions to:
generate a road section by dividing, by meshes, a movement path of a moving body collected from the moving body moving on a road, the meshes being obtained by dividing a ground surface into a predetermined size; and
determine and output a state of the road section based on sensor information of the road section collected from the moving body.

2. The infrastructure diagnostic device according to claim 1, wherein the at least one processor is further configured to execute the instructions to:
generate a route that is a set of road sections connected between adjacent meshes.

3. The infrastructure diagnostic device according to claim 2, wherein the at least one processor is further configured to execute the instructions to:
receive designation of road sections to be connected between adjacent meshes; and
generate a set of road sections including the designated road sections as the route.

4. The infrastructure diagnostic device according to claim 2, wherein the at least one processor is further configured to execute the instructions to:
specify, based on one or more positions on a predefined route and based on a position on the generated route, the route as the predefined route.

5. The infrastructure diagnostic device according to claim 1, wherein the at least one processor is further configured to execute the instructions to:
assign a pair of an identifier for identifying a mesh and an identifier for identifying the road section in the mesh, as an identifier of the road section.

6. The infrastructure diagnostic device according to claim 1, wherein the at least one processor is further configured to execute the instructions to:
assign different identifiers to different directions on the road section.

7. The infrastructure diagnostic device according to claim 1, wherein the at least one processor is further configured to execute the instructions to:
in a case that a distance between the different road sections generated in a same mesh is within a predetermined range, integrate the different road sections into one road section.

8. An infrastructure diagnostic method comprising:
generating a road section by dividing, by meshes, a movement path of a moving body collected from the moving body moving on a road, the meshes being obtained by dividing a ground surface into a predetermined size; and
determining and outputting a state of the road section based on sensor information of the road section collected from the moving body.

9. A recording medium recording a program for causing a computer to execute processing of:
generating a road section by dividing, by meshes, a movement path of a moving body collected from the moving body moving on a road, the meshes being obtained by dividing a ground surface into a predetermined size; and
determining and outputting a state of the road section based on sensor information of the road section collected from the moving body.
